(19) United States
(12) Patent Application Publication
(10) Pub. No.: US 2013/0132574 A1
(43) Pub. Date: May 23, 2013

(54) TRANSMITTING AND RECEIVING INFORMATION ASSOCIATED WITH WI-FI HOTSPOTS

(71) Applicant: Leigh M. Rothschild, Sunny Isles Beach, FL (US)

(72) Inventor: Leigh M. Rothschild, Sunny Isles Beach, FL (US)

(73) Assignee: ARIEL INVENTIONS LLC, Sunny Isles Beach, FL (US)

(21) Appl. No.: 13/470,308

(22) Filed: May 12, 2012

Related U.S. Application Data
(60) Provisional application No. 61/485,611, filed on May 12, 2011.

(51) Int. Cl. H04W 28/02

(52) U.S. Cl. CPC H04W 28/02
USPC 709/225

(57) ABSTRACT

Systems, methods and devices for providing information to a user from a wireless network operator. Embodiments include detecting a wireless network using a user device and receiving wireless network information and operator information from a wireless network router before having access to the wireless network. Further. embodiments include identifying an operator website address using the operator information and accessing the operator website. In addition, the user device may be provided partial access to the wireless network by the wireless router such that the user device accesses the operator website through the wireless network. Also, the operator information includes at least one of an operator website address and a code string. Embodiments include sending the code string to a remote computer server and receiving the operator website address from the remote computer server based on processing the code string.

### CROSS-REFERENCE TO RELATED APPLICATIONS

The present application claims priority under the laws and rules of the United States, including 35 USC §120, to U.S. Provisional Patent Application No. 61/485,611 filed May 12, 2011. The contents of U.S. Provisional Patent Application No. 61/485,611 are herein incorporated by reference in its entirety.

### BACKGROUND

“Wi-Fi” is a term used to describe only a narrow range of connectivity technologies including wireless local area network (WLAN) based on the IEEE02.11 standards device to device connectivity (such as Wi-Fi Peer to Peer AKA Wi-Fi Direct), and a range of technologies that support PAN, LAN, and WAN connections. The technical term “IEEE 802.11” has been used interchangeably with Wi-Fi, but over the past few years Wi-Fi has become a superset communication networks that use the IEEE 802.11 family of standards.

The term Wi-Fi Hotspot is derived from the term Wi-Fi. Further, a Wi-Fi hotspot can be a public place that connects a computing device (e.g. smartphone, tablet computer, laptop computer, etc.) wirelessly to the Internet. A Wi-Fi hotspot may refer to the area covered by the Wi-Fi communication network. These hotspots, which can be found in airports, coffee bars, bookshops, and college campuses, use one or more wireless routers to generate a wireless (e.g. Wi-Fi) network to provide access to the Internet. Coffee shops, hotels or airports install a wireless router with Internet access for generating Wi-Fi communication networks for public use. In many cases such access is free, though some Wi-Fi hotspots operators may require users pay for access.

With respect to Wi-Fi hotspots, the wireless router generating the WiFi communication network provide wireless connectivity to the Internet. A wireless router serves two purposes. First, the wireless router provides connectivity to computing devices connected to the wireless router. Second, the wireless router provides the connected computing devices with Internet access. A wireless router provides such connectivity to the computing devices wirelessly without requiring the computers to be physically connected to the wireless router or to each other.

A computing device can only use a wireless network if the computer has a wireless card, which may receive and transmit information to the wireless router destined to other computers connected to the WiFi network or to destination across the Internet. Using the wireless card, the computing device can detect and access Wi-Fi hotspots within the transmission range supported by the wireless card and the wireless router.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the present disclosure is not limited to the precise arrangements and instrumentalities shown, wherein:

FIG. 1 is an exemplary network diagrams of exchanging information between user device, wireless router, and a remote server through a wireless communication network;

FIG. 2 is an exemplary functional block diagram of a user device;

FIG. 3 is an exemplary functional block diagram of an operator broadcasting system;

FIGS. 4A-4C are flowcharts of example methods of exchanging information between user device, wireless router, and a remote server through a wireless communication network.

### DETAILED DESCRIPTION

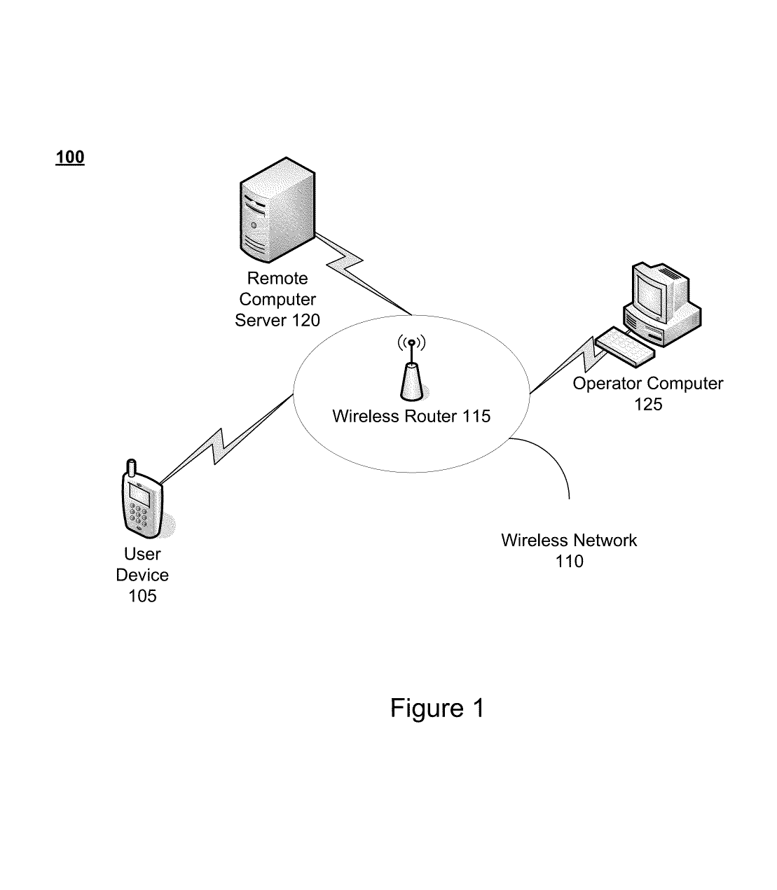

FIG. 1 is functional diagram 100 of system for providing information to a user from a wireless network operator. The system includes a user device 105, a wireless network 110, a wireless router 115, a remote computer server 120, and an operator computer 125. The wireless router 115 is owned or operated by the wireless network operator. Further, the wireless network operator may be, for example, a coffee shop, hotel, physician office, spa, or any other business or entity operating a wireless or Wi-Fi network or Wi-Fi hotspot. The wireless router 115 provides or broadcasts operator information to the user device 105 using an operator software application before the wireless router provides the user device access to the wireless communication network. Further, in alternative embodiments, the wireless network information and operator information are continuously broadcasted by the wireless router 115. Moreover, in other embodiments, the operator information is provided to the user device by the operator before the user device requests the operator information such as the operator website. That is, the in traditional wireless communication networks, the user device may be given partial access to the wireless network and the operator provides or the user device accesses an operator website address. Subsequently, the user may provide security credentials and/or accept terms of service requested by the operator on the operator website. After authentication, the operator provides the user device full access to the wireless network. In alternative embodiments, the operator provides the operator website address before providing the user device partial access to the wireless network to request access to the operator website. The operator information may include the name of the wireless network 110 and a website address or link associated with the operator. The user device 105 detects the wireless network 110 via a user wireless card and wireless network application installed on the user device. Further, the user device 105 receives operator information such as wireless network information (e.g. name security protocols, etc.) and an operator website address. The user device processes the operator information to determine the operator website address and then may selectively access the operator website using an Internet software application, such as a web browser. The user device 105 can be, but not limited to, any mobile device such as a smartphone. mobile phone, tablet computer, notebook computer, laptop computer, global positioning system, or any other mobile device.

In one embodiment, the user device may be a smartphone such that it can access the operator website (after identifying the operator website address) through a cellular communication network or some other communication network. In alternative embodiments, the user device (mobile phone, smartphone, tablet computer, notebook, computer, laptop computer, etc.) may be provided partial access to the wireless network by the wireless router such that the user device accesses the operator website through the wireless network.

Although operator information includes a website address or link to a website as well as the name of the wireless communication network, the operation information may include, but is not limited to, name of operator, address of geographic location of operator, security protocols of the wireless network, e-commerce information of using the wireless communication network, email address of operator, social networking information of operator, operator website address information, operator phone number, operator advertising material, operator promotional material, operator marketing material, operator retail offers, operator navigation information, operator parking information, operating hours and a combination thereof.

In a further embodiment, the operator information provided by the wireless router 115 may not include an operator website address. Instead the operator information may include a code string. Thus, the user device 105, upon receiving the operator information determines that the operator information includes the code string. Further, the user device 105 accesses the remote computer server 120 and provides the remote computer server with the code string. The remote computer server 120 processes the code string and determines the operator website address. For example, the remote computer server 120 may associate each website address of many different wireless network operators by a distinct code string in a database. Thus, the remote computer server 120 may search for the code string in the database and then determine the operator website address associated with the code string. Subsequently, the remote computer server transmits the operator websites associated with the code string to the user device 105. The user device 105 receives the operator website address and can then access the website using an Internet software application such as a web browser.

In an additional embodiment, the user device 105 accesses the wireless network 110. This may include providing the wireless router with security credentials such as a user name and password or security key to access the wireless network 110. Further, the user device 105 provides the wireless router 115 with user information, such as the user name or account information to an operator computer 125. Upon receiving the user information, the operator can determine the user associated with the user information. For example, the operator may be a physician's office and receives the user information, such as the name of the user or patient. Using the operator computer 125, the operator/physician office determines that the user has an imminent appointment and checks in the user/patient for her appointment. In another example, the operator may be a spa and receives user information such as the name of the user. Using a computer, the operator/spa determines that the user has an imminent facial or massage appointment and checks in the user for her appointment.

Further, the user device 105 receives marketing material from the operator computer 125 based on the user information, wherein the marketing material is provided by the operator based upon the user information. For example, if the operator is a spa, the operator computer may determine that this is the fourth spa appointment in a month for the user. Thus, the operator spa sends marketing material to the user device 105 in the form a frequent user/rewards program application. Upon receiving the marketing material on the user device 105, the user provides a response to the operator. Continuing with the spa example, the response confirms enrollment in the frequent user/rewards program. The marketing material can be, but not limited to, a coupon, discount, rebate, promotion, advertisement, or a combination thereof. In addition, the marketing material may include symbology such as a bar code or QR code capable of being scanned by an operator computing device (e.g. point of sale device). Symbology includes any bar code or QR code that may include an UPC code as well as other linear bar codes and symbology. Further symbology may also include Matrix or two dimensional codes. For example, the user may receive a coupon with a bar code for a free spa treatment on the user device 105. After receiving the spa treatment, the user device 105 may present the coupon with bar code on the display of the user device 105. The operator computing device (e.g. point-of-sale device) scans the bar code and registers the free spa treatment for the user.

In the embodiment shown in FIG. 1, the wireless router 115 and operator computer 125 are shown to be separate devices. However, other embodiments may have the wireless router and operator computer coupled together as one operator broadcasting system or two separate devices coupled together to act as an operator broadcasting system.

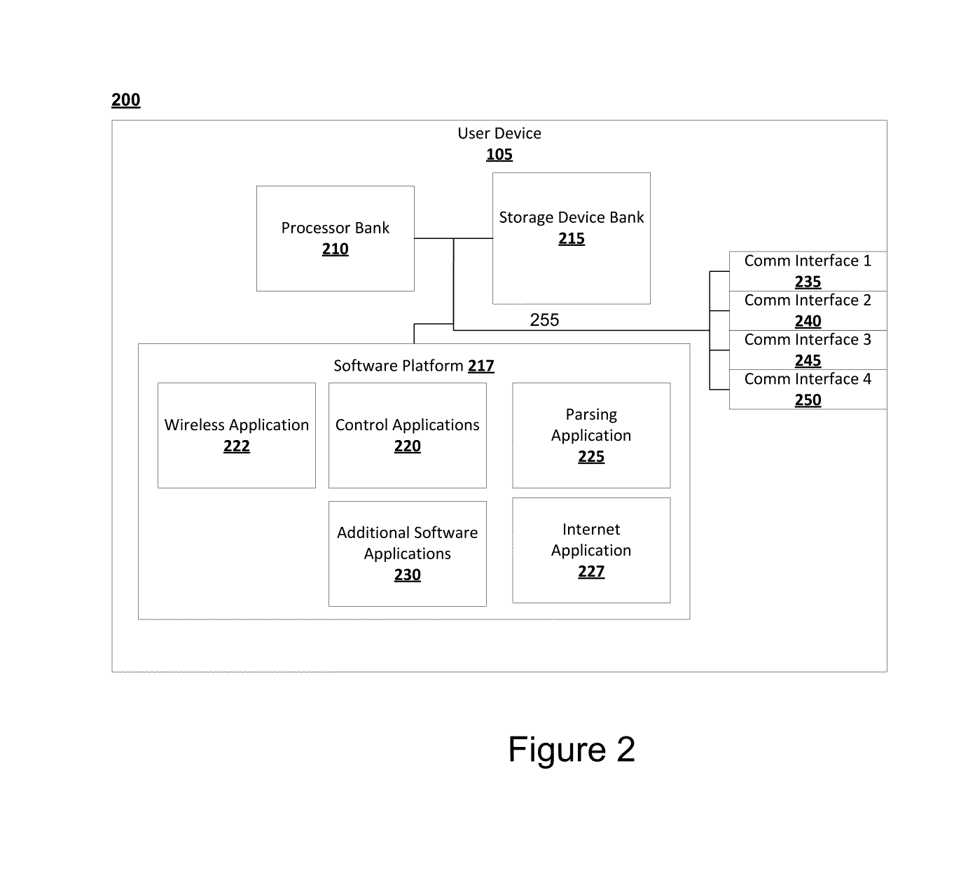

FIG. 2 is an exemplary functional block diagram 200 of a user device 105. Such a user device 105 may be include several components such as a processor bank 210, storage device bank 215, a software platform 217, and one or more communication interfaces (235-250).

The processor bank 210 may include one or more processors that may be co-located with each other or may be located in different parts of the user device 105. The storage device bank 215 may include one or more storage devices. Types of storage devices may include memory devices, electronic memory, optical memory, and removable storage media.

The one or more software applications 217 may include a control applications 220, wireless application 222, parsing application 225, Internet application 227, and additional software applications 230. Further, the wireless application 222 assists in performing certain tasks for the user device 105, such as providing access to a communication network (e.g. wired, wireless, Bluetooth, infra-red, RF, etc.) by providing a user name and password or a security key to access a communication network. Further, wireless application 222 detects a wireless network using a user wireless card. The control applications 220 may then receive wireless network information (e.g. security protocols, wireless network name, etc.) and operator information provided by an operator of a wireless communication network.

Further, the parsing software application 225 of the software platform 217 may process the operator information. In one embodiment, the operator information may include the operator website address. The parsing application 225 processes the operator information and determines the operator website address, which then passes the operator website address to the Internet software application 227 such as a web browser. The Internet application 227 accesses the operator website based on the operator website address and presents the operator website to the user.

In another embodiment, the operator information provided by the wireless router may not include an operator website address. Instead the operator information may include a code string. Thus, the parsing application 225, upon receiving the operator information, determines that the operator information includes the code string. Further, the parsing application 225 accesses a remote computer server and provides the remote computer server with the code string. The remote computer server processes the code string and determines the operator website address. For example, the remote computer server 120 associates each website address of many different wireless network operators by a distinct code string in a database. Thus, the remote computer server 120 may search for the code string in the database and then determine the operator website address associated with the code string. Subsequently, the remote computer server transmits the operator websites associated with the code string to the user device 105 and the parsing application 225. Further, parsing application passes the operator website address to Internet application 227, which accesses the website and presents the website to the user.

In another embodiment, the wireless application 222 accesses the wireless network and provides the operator with user information (e.g. user name or account information) such that the operator can determine a user associated with the user information. Upon receiving the user information, the operator can determine the user associated with the user information. For example, the operator may be a physician's office and receives user information such as the name of the user or patient. Using a computer, the operator/physician office determines that the user has an imminent appointment and checks in the user/patient for her appointment. In another example, the operator may be a spa and receives user information such as the name of the user. Using a computer, the operator/spa determines that the user has an imminent facial or massage appointment and checks in the user for her appointment.

In a further embodiment, the wireless application 222 receives marketing material from the operator. The marketing material is provided based on the user information. Upon receiving the marketing material, the wireless application 222 causes the marketing material to be presented to the user on the display of the user device 105. The user device 105 provides a response to the marketing material to the operator. For example, if the operator is a spa, an operator computer receiving the user information may determine that this is the fourth spa appointment in a month for the user. Thus, the operator spa sends marketing material to the user device 105 in the form a frequent user/rewards program application.

Upon viewing the marketing material on the user device 105, the user provides a response to the operator. Continuing with the spa example, the response confirms enrollment in the frequent user/rewards program through its Internet application 227. The marketing material can be, but not limited to, a coupon, discount, rebate, promotion, advertisement, or a combination thereof. In addition, marketing material may include symbology such as a bar code or QR code capable of being scanned by an operator computing device (e.g. point of sale device). For example, the user may receive a coupon with a bar code for a free spa treatment on the user device 105. After receiving the spa treatment, the user device 105 may present the coupon with the bar code on the display of the user device 105. The operator computing device (e.g. point-of-sale device) scans the bar code and registers the free spa treatment for the user.

Control applications 220 and additional software applications 230 may also include functions such as executing an operating system, managing software drivers for peripheral components, and processing information. In addition, the additional and control application (220 and 230) may also include software drivers for peripheral components, user interface computer programs, debugging and troubleshooting software tools. Also, the control and additional software applications (220 and 230) may include an operating system known in the art (e.g. Windows 7, Linux, UNIX, previous version of Windows and MacOS, etc.).

Each of the communication interfaces (235-250) shown in FIG. 2 may be software or hardware associated in communicating to other devices. The communication interfaces (235-250) may be of different types that include a user interface, USB, Ethernet, WiFi, WiMax, wireless, optical, cellular, or any other communication interface coupled to communication network.

An intra-device communication link 255, between the processor bank 210, storage device bank 215, software applications 217, and communication interfaces (235-250), may be one of several types that include a bus or other communication mechanism.

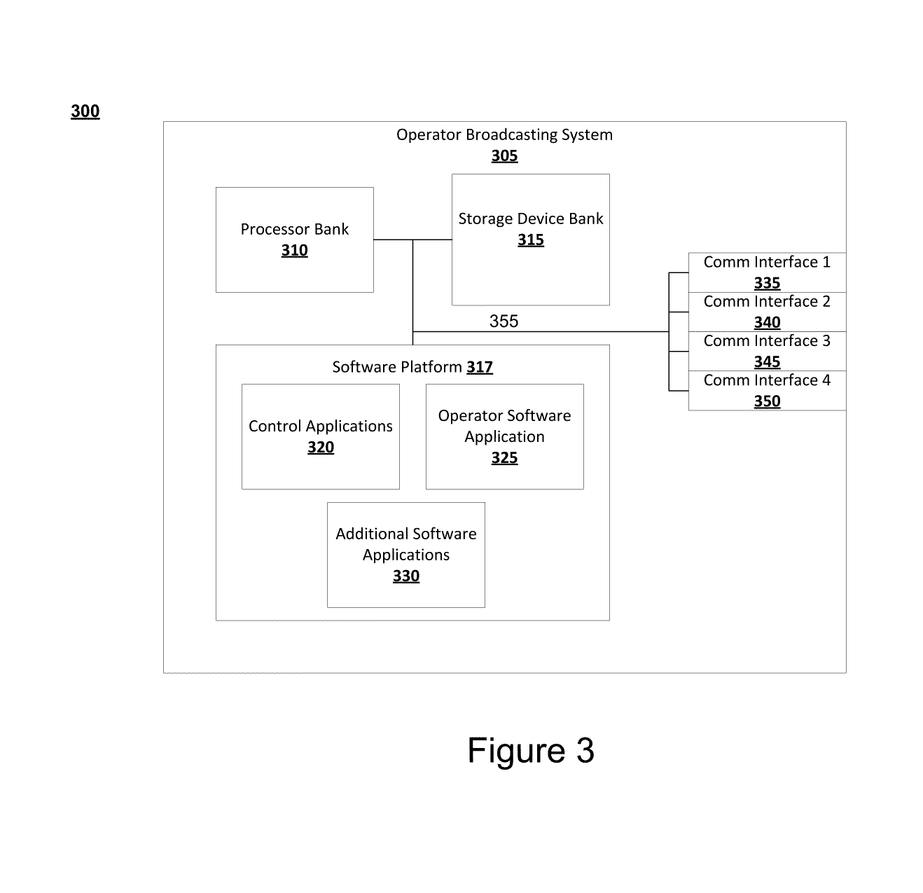

FIG. 3 is an exemplary functional block diagram 300 of an operator broadcast system 305. In the embodiment shown in FIG. 3, the wireless router and operator computer are shown to be on operator broadcasting system. However, in other embodiments the wireless router and operator computer may be separate devices coupled together as one operator broadcasting system. Such an operator broadcasting system 305 may be include several components that includes a processor bank 310, storage device bank 315, a software platform 317, and one or more communication interfaces (335-350).

The processor bank 310 may include one or more processors that may be co-located with each other or may be located in different parts of the operator broadcasting system 305. The storage device bank 315 may include one or more storage devices. Types of storage devices may include memory devices, electronic memory, optical memory, and removable storage media.

The one or more software applications 317 may include control applications 320, operator software applications 325 and additional software applications 330. The operator software application 325 allows the operator broadcasting system 305 to provide operator information to a user device. In one embodiment, the operator information includes, but is not limited to, the name of the wireless network and the operator website address or link. The user device can then access the operator website based on the operator website address. In another embodiment, the operator information may not include the operator website address but instead includes a code string. The user device can access a remote computer server and provide the code string. Further, the remote computer server may process the code string to determine an operator website address and transmit such website address to the user device.

In a further embodiment, the operator application 325 receives user information from a user device to store in the one or more storage devices. The user information may include, but is not limited to, the user name or account information. Further, the operator application 325 determines a user associated with the user information. In addition, the operator application may provide marketing material to the user device from the operator based on the user information. For example, the operator may be a spa and the operator application 325 receives the user name from user device. The operator application 325 determines, based on the user name, that the user has received a spa treatment in each of the last four weeks. Thus, the operator application 325 provides marketing material to the user device in the form of frequent user/rewards program enrollment application.

Further, the operator software application 325 may receive a response to the marketing material from the user device. For example, the user may confirm enrollment in a spa frequent user/rewards program. In addition, the operator software application 325 modifies or updates the user information in the storage device based on the response. That is, the operator software application 325 may update the user information to indicate the user has enrolled in the spa's frequent user/rewards program.

In another embodiment, the marketing material can be a coupon, discount, rebate, promotion, advertisement, or a combination thereof. Further, the marketing material includes symbology capable of being scanned by an operator computing device. For example, the marketing material can be a coupon with a bar code or QR code. The coupon may be provided to the user device and saved in a user device memory or storage device. Further, the user may purchase item from the operator and then render the coupon to an operator computing device (e.g. an operator point-of-sale terminal). The operator computing device has a scanning device that is capable of reading the bar code or QR code from the coupon and apply the coupon to the purchase transaction.

In some embodiments, the wireless router may be coupled to an operator computer such that a subset of software applications and a subset of hardware components shown in FIG. 3 may be located either within wireless router, an operator computer, or both.

Further, the control and additional software applications (320 and 330) may include control software applications that implement software functions that assist in performing certain tasks for the operator broadcasting system 305 such as providing access to a communication link (e.g. wired, wireless, Bluetooth, infra-red, RF, etc.) executing an operating system, managing software drivers for peripheral components, and processing information. In addition, the control and additional software applications (320 and 330) may also include software drivers for peripheral components, user interface computer programs, debugging and troubleshooting software tools. Also, the control and additional software applications (320 and 330) may include an operating system known in the art (e.g. Windows 7, Linux, UNIX, previous version of Windows and MacOS, etc.).

Each of the communication interfaces (335-350) shown in FIG. 3 may be software or hardware associated in communicating to other devices. The communication interfaces (335-350) may be of different types that include a user interface, USB, Ethernet, WiFi, WiMax, wireless, optical, cellular, or any other communication interface coupled to communication network.

An intra-device communication link 355 between the processor bank 310, storage device bank 315, software applications 317, and communication interfaces (335-350) may be one of several types that include a bus or other communication mechanism.

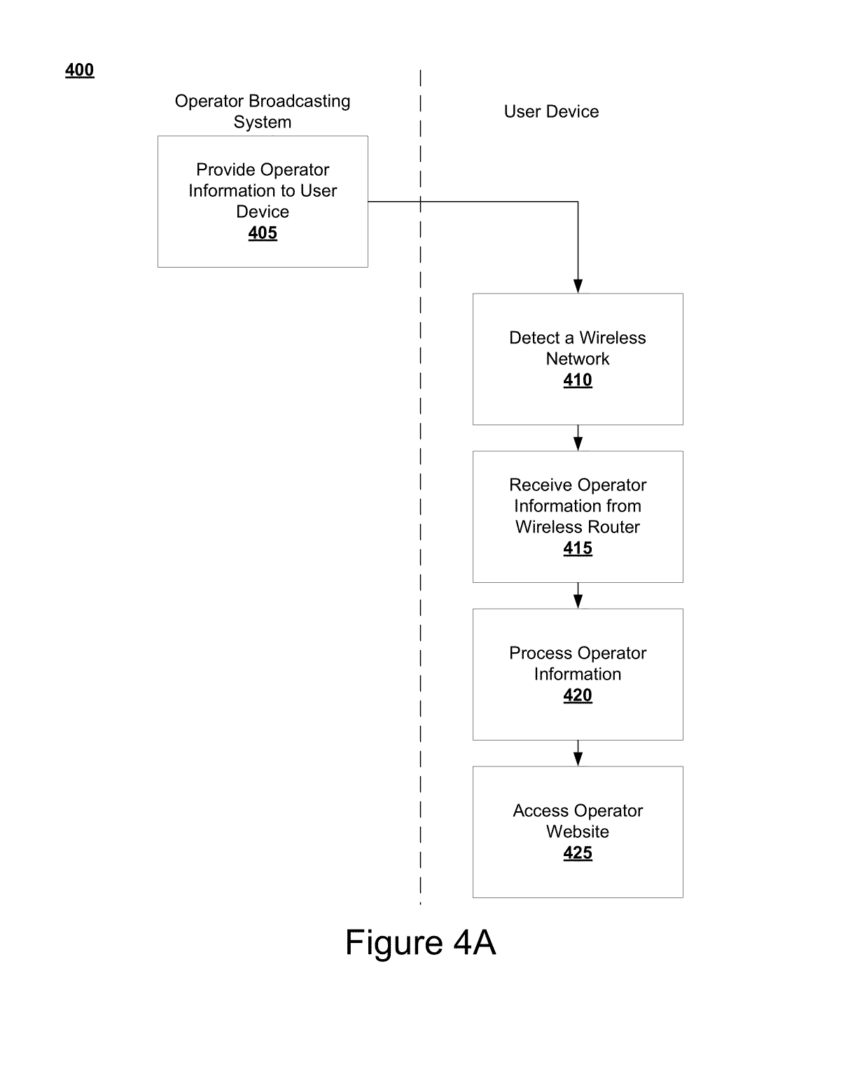

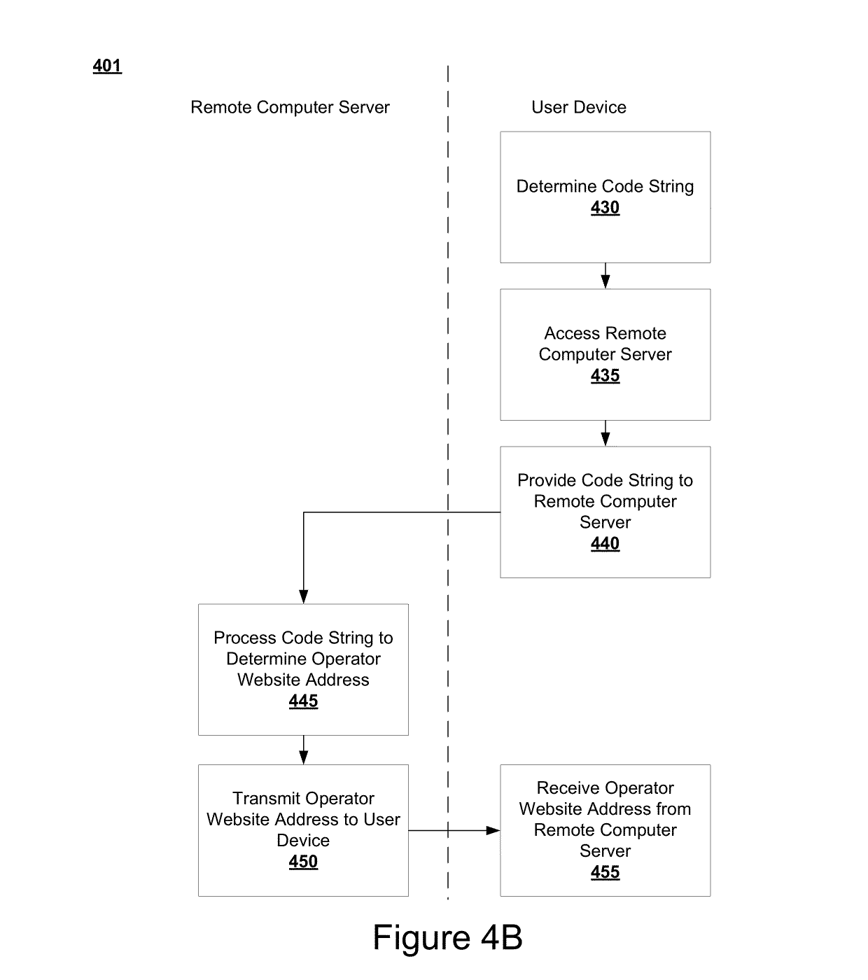

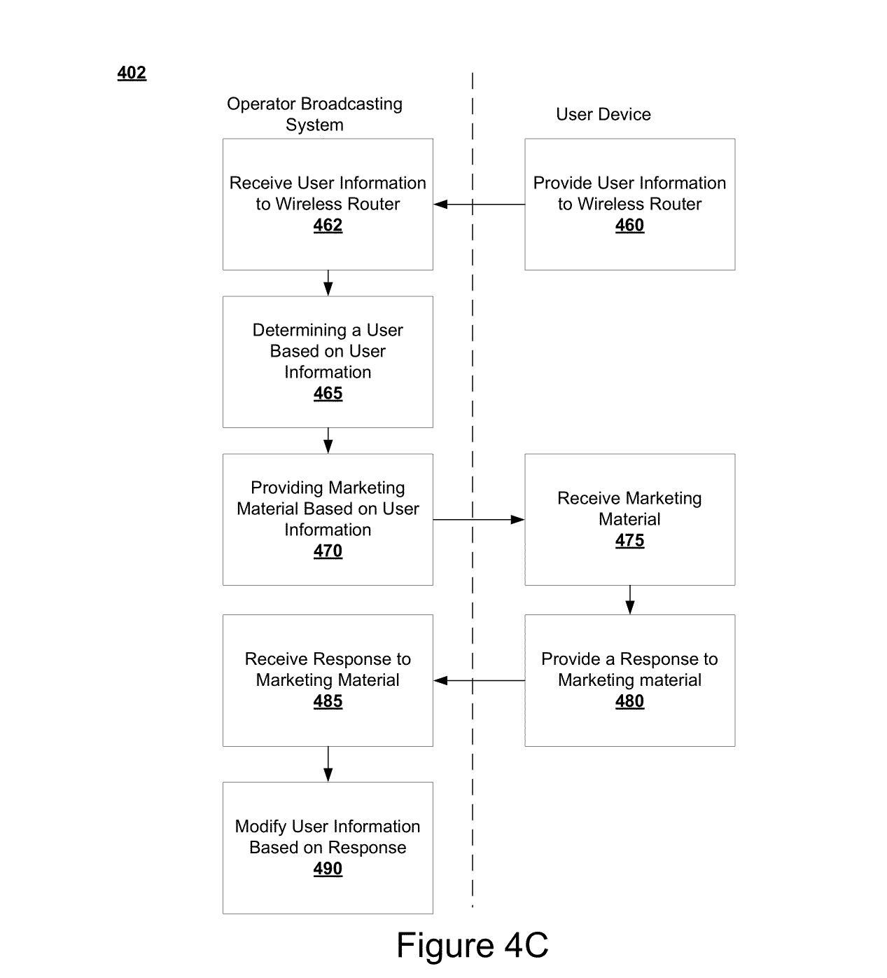

FIGS. 4A-4C are exemplary flow charts (400-402) illustrating example methods of exchanging information between an operator and a user. Referring to FIG. 4A, an example method includes providing or broadcasting operator information to a user device using an operator wireless router/operator computer before the wireless router provides the user device access to the wireless communication network, as shown in block 405. Further, in alternative embodiments, the wireless network information and operator information are continuously broadcasted by the wireless router 115. Moreover, in other embodiments, the operator information is provided to the user device by the operator before the user device requests the operator information such as the operator website. That is, the in traditional wireless communication networks, the user device may be given partial access to the wireless network and the operator provides or the user device accesses an operator website address. Subsequently, the user may provide security credentials and/or accept terms of service requested by the operator on the operator website. After authentication, the operator provides the user device full access to the wireless network. In alternative embodiments, the operator provides the operator website address before providing the user device partial access to the wireless network to request access to the operator website. The method further includes detecting a wireless network by a user device with a user wireless card and wireless network application, as shown in block 410. Additionally, the method includes receiving wireless network information and operator information from the operator wireless router/computer, as shown in block 415. Moreover, the method includes processing the operator information using a parsing application to determine an operator website address based on the operator information, as shown in block 420. The method also includes accessing the operator website with an Internet application on the user device, as shown in block 425.

Referring to FIG. 4B, an example method includes the user device determining that the operator information includes code string, as shown in block 430. The method further includes accessing a remote computer server by the user device and providing the remote computer server the code string, as shown in blocks 435 and 440, respectively. The remote computer server processes the code string and determines the operator website address, as shown in block 445. For example, the remote computer server is coupled to a database where operator website addresses are stored according to a unique code string. Thus, the remote computer server searches the database based on the received code string and determines the associated operator website address. The remote computer server transmits and the user device receives the operator website address, as shown in blocks 450 and 455, respectively.

Referring to FIG. 4C, an example method includes a user device providing and the operator wireless router/computer receiving user information, as shown in blocks 460 and 462, respectively. The operator wireless router/computer using an operator software application determines a user based on the user information. For example, the operator may be a retail electronics store that determines the user has purchased four items in the past two weeks from the retailer. Thus, the operator may provide the user device with marketing material based on the user information, as shown in block 470. For example, the retail electronics store may provide a rewards program enrollment form to the user device. The method further includes the user device receiving marketing material and the user device providing a response to the marketing material, as shown in blocks 475 and 480. For example, the user may provide confirmation to enroll in the rewards program offered by the retail electronics store as a response to the marketing material. The operator wireless router/computer receives the response to the marketing material from the user device and modifies the user information based on the response, as shown in blocks 485 and 490. For example, the retail electronics store receives confirmation from the user to enroll in the rewards program and updates its user information indicating the user's participation in the rewards program.

Persons of ordinary skill in the art would understand that the software applications described herein can be implemented a computer processor. Further, the methods disclosed herein may be implemented by a computer in software and/or stored in a computer readable medium.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for providing information to a user from a wireless network operator, the method comprising:
detecting a wireless network using a user device;
receiving wireless network information and operator information from a wireless network router before having access to the wireless network;
identifying an operator website address using the operator information;
accessing the operator website.

2. The method of claim 1, wherein the user device is provided partial access to the wireless network by the wireless router such that the user device accesses the operator website through the wireless network.

3. The method of claim 1, wherein the operator information includes at least one of an operator website address and a code string.

4. The method of claim 3, further comprising:
sending the code string to a remote computer server; and
receiving the operator website address from the remote computer server based on processing the code string.

5. The method of claim 1, further comprising sending user information to the operator via the wireless network.

6. The method of claim 5, further comprising:
receiving operator material from the operator wherein the operator material is provided based on the user information; and
providing a response to the operator material to the operator.

7. The method of claim 6, wherein the operating material includes symbology.

8. A user device for providing information to a user from a wireless network operator, comprising:
at least one processor configured to initiate or perform:
detecting a wireless network;
receiving wireless network information and operator information from a wireless network router before having access to the wireless network;
identifying an operator website address using the operator information;
accessing the operator website.

9. The user device of claim 8, wherein the user device is provided partial access to the wireless network by a wireless router such that the user device accesses the operator website through the wireless network.

10. The user device of claim 8, wherein the operator information includes at least one of an operator website address and a code string.

11. The user device of claim 10, wherein:
the at least one processor is further configured to initiate or perform:
sending the code string to a remote computer server; and
receiving the operator website address from the remote computer server based on processing the code string.

12. The user device of claim 8, wherein:
the at least one processor is further configured to initiate or perform sending user information to the operator via the wireless network.

13. The user device of claim 8, wherein:
the at least one processor is further configured to initiate or perform:
receiving operator material from the operator wherein the operator material is provided based on the user information; and
providing a response to the operator material to the operator.

14. The user device of claim 13, wherein the operator material includes symbology.

15. A method for providing information to a user from a wireless network operator, the method comprising broadcasting wireless network information and operator information to a user device before providing access of the wireless network.

16. The method of claim 15, further comprising:
receiving user information from a user device;
storing the user information in a storage device;
identifying a user based on the user information.

17. The method of claim 15, further comprising:
sending operator material to the user device wherein the operator material is based on the user information;
receiving a response to the operator material from the user device;
modifying the user information in the storage device based on the response.

18. The method of claim 15, wherein the wireless network information and operator information are continuously broadcasted before providing access to the wireless network.

19. The method of claim 15, wherein the operator information is provided to the user device by the operator before the user device requests any operator information.

20. The method of claim 15, wherein the operator information includes at least one of a website address and a code string.

21. The method of claim 17, wherein the operator material includes symbology.

22. An operator broadcasting system for providing wireless network operator information, comprising at least one processor configured to initiate or perform broadcasting wireless network information and operator information to a user device before providing access of the wireless network.

23. The operator broadcasting system of claim 22, wherein the operator information includes at least one of a website address and a code string.

24. The operator broadcasting system of claim 22, wherein
the at least one processor is further configured to initiate or perform:
receiving user information from a user device;
storing the user information in a storage device;
identifying a user based on the user information.

25. The operator broadcasting system of claim 22, wherein
the at least one processor is further configured to initiate or perform:
sending operator material to the user device wherein the operator material is based on the user information;
receiving a response to the operator material from the user device;
modifying the user information in the storage device based on the response.

26. The operator broadcasting system of claim 22, wherein the wireless network information and operator information are continuously broadcasted before providing access to the wireless network.

27. The operator broadcasting system of claim 22, wherein the operator information is provided to the user device before the user device requesting the operator information.

28. The operator broadcasting system of claim 22, wherein the operator information includes at least one of a website address and a code string.

29. The operator broadcasting system of claim 25, wherein the operator material includes symbology.
